(19) United States
(12) Patent Application Publication
(10) Pub. No.: US 2008/0021956 A1
(43) Pub. Date: Jan. 24, 2008

(54) METHOD AND SYSTEM FOR PROVIDING PART SELECTION INFORMATION BASED ON WIRELESS NETWORK

(75) Inventors: Dae-Wha SEO, Daegu (KR); Yun-Jung LEE, Daegu (KR); Hong-Rok KIM, Daegu (KR); Byeong-Jun CHOI, Daegu (KR); Jeen-Hong PARK, Yeongcheon-si (KR)

Correspondence Address: THE RAFFERTY PATENT LAW FIRM, 5641 BURKE CENTRE PKWY, SUITE 100, BURKE, VA, 22015-2259, US

(73) Assignee: KYUNGPOOK NATIONAL UNIVERSITY INDUSTRY-ACADEMIC COOPERATION FOUNDATION, Daegu (KR)

(21) Appl. No.: 11/771,043

(22) Filed: Jun. 29, 2007

(30) Foreign Application Priority Data
Jul. 19, 2006 (KR) 10-2006-0067461

(51) Int. Cl. G06F 15/173

(52) U.S. Cl. 709/203

(57) ABSTRACT

A system for providing part selection information based on a wireless network is provided. The system includes a wireless network, a plurality of display terminals adhered to a plurality of boxes including predetermined parts which display part receipt guidance information based on externally received part selection command, and a management computer which controls and manages an operation of the entire system. The management computer includes a management table to which identification information on parts and display terminals is mapped. The management computer transmits the part selection command to a display terminal corresponding to identification information on the display terminal that is externally input. Accordingly, it is possible to provide receipt information on predetermined goods or parts by adhering the display terminals for displaying the part receipt information to boxes including goods or parts and by displaying part receipt guidance information on the display terminals adhered to the boxes including the parts.

### CROSS-REFERENCE TO RELATED PATENT APPLICATION

This application claims the benefit of Korean Patent Application No. 10-2006-0067461, filed on Jul. 19, 2006, in the Korean Intellectual Property Office, the disclosure of which is incorporated herein in its entirety by reference.

### BACKGROUND

1. Field of the Invention

The present invention relates to a system for managing parts, and more particularly, to a system and method for providing part selection information capable of provide receipt information on the parts to a worker.

2. Description of the Related Art

In general, a physical distribution management system transports necessary goods or parts suitably to a manufacture process. The physical distribution management system is disclosed in Korean Patent Application No. 1996-0045090 entitled “Physical Distribution system of Semiconductor Manufacturing Plant”.

The aforementioned physical distribution system is constructed with an automatic return vehicle which returns goods to be transported; a control unit which manages production information and physical distribution information on the goods to be transported and outputs control information for returning the goods when a return takes place; and an automatic return vehicle control unit which reads the control information and controls the transportation and the operation of the automatic return vehicle for returning the goods through communication.

The physical distribution system allows goods or parts in the physical distribution system to be systematically and effectively operated and managed by transporting and returning the goods or parts needed for a worker through the automatic return vehicle.

When kinds of goods and parts required in a working process are various and when goods and parts needed for each process are different, it is difficult to selectively receive only parts needed for each process among automatically transported physical distribution or physical distribution and parts included in a material rack.

In the past, a worker can identifies necessary parts by using bills. As described above, it takes a long time to identify necessary parts by using bills. In addition, it is highly probable that errors take place in processes.

Accordingly, there is required development of a technique capable of allowing a worker to easily recognize information on goods or parts to be received.

### SUMMARY

An object of the present invention is to provide a system and method for providing part selection information capable of allowing a worker to easily recognize parts to be received by adhering a display terminal to a box including parts and by displaying part receipt guidance information through the display terminal based on a part selection command provided from a management computer.

According to an aspect of the present invention, there is provided a system for providing part selection information, the system comprising: a wireless network; a plurality of display terminals adhered to a plurality of boxes including predetermined parts, which displays receipt information on corresponding parts, in response to a part selection command received through the wireless network; and a management computer including a management table to which identification information on the parts and identification information on the display terminals, which transmits the part selection command to a display terminal corresponding to identification information on parts or identification information on a display terminal through the wireless network, when receiving the identification information on the parts or identification information on the display terminal.

In the above aspect of the present invention, a display terminal may be adhered to a box including goods or parts (hereinafter, abbreviated to parts), and the display terminal may display receipt guidance information on corresponding parts, in response to the part selection command received from the management computer. Accordingly, a worker can easily identify parts to be received with reference to the receipt guidance information displayed on the display terminal of the box.

In addition, when receiving identification information on parts to be received or identification information on a display terminal adhered to a box including the parts to be received through the management computer or a network computer, the management computer may turn on a lamp unit of the display terminal by transmitting the part selection command to the display terminal to notify the worker of receipt guidance information on the corresponding parts.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating a system for providing part selection information according to an embodiment of the present invention;

FIG. 2 illustrates an example of a part management table according to an embodiment of the present invention;

FIG. 3 a block diagram illustrating a display terminal according to an embodiment of the present invention; and

FIG. 4 is a functional block diagram illustrating a method of providing part selection information according to an embodiment of the present invention.

### DETAILED DESCRIPTION

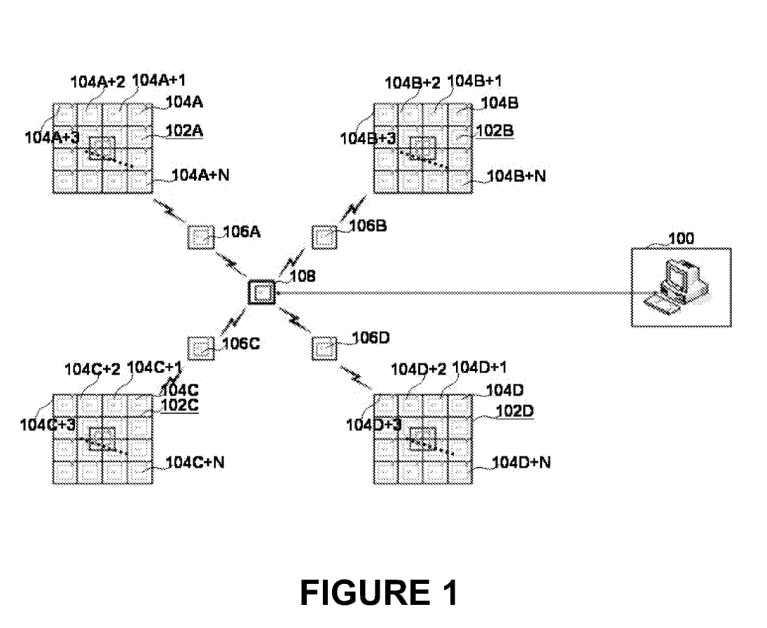

A system for providing part selection information according to an exemplary embodiment of the present invention will be described with reference to FIG. 1.

The system for providing part selection information largely includes a management computer 100, a plurality of display terminals 104A to 104D+N for displaying information on receiving of parts, which are adhered to boxes of the parts in a plurality of material racks 1 02A to 102D respectively, a plurality of wireless routers 106A to 106H which interface the display terminals 104A to 104D+N with a personal area network (PAN) coordinator 108, and a PAN coordinator 108 which interfaces the plurality of wireless routers 106A to 106H with the management computer 100.

The management computer 100 generally controls the system for providing the part selection information. Specifically, when a manager inputs identification information on a display terminal or identification information on parts into the management computer 100, the management computer 100 transmits a part selection command to a display terminal corresponding to the identification information on the display terminal or identification information on the parts. In addition, when receiving receipt confirmation information from the display terminal, the management computer 100 transmits a command for terminating selection of parts to the display terminal.

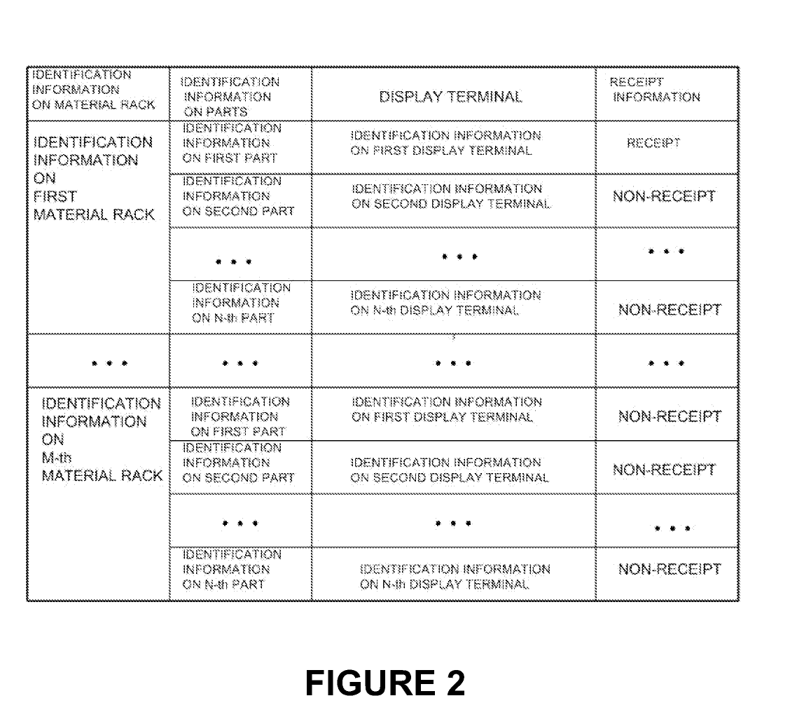

In addition, the management computer 100 manages a part management table in an internal memory. As shown in FIG. 2, the part management table stores identification information on parts included in each material rack 102A to 102D, identification information on the display terminals, and receipt confirmation information on the parts in correspondence with one another.

Each display terminal 104A to 104D+N turns on a lamp unit, in response to a part selection command transmitted from the management computer 100 and displays receipt guidance information on parts through an information display unit 208. Selectively, each display terminal 104A to 104D+N transmits receipt confirmation information to the management computer 100, in response to a click of a receipt button from a worker. Selectively, each display terminal 104A to 104D+N turns off the lamp unit and deletes the part receipt guidance information from the information display unit, in response to a command for terminating selection of parts provided from the management computer.

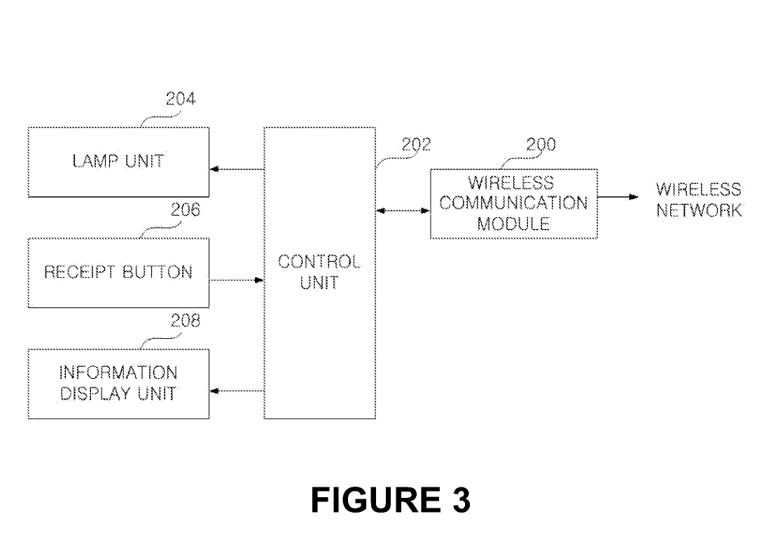

Since structures and operations of the display terminals 104A to 104D+N are the same, a structure and an operation of a display terminal 104A will now be described in detail with reference to FIG. 3.

The display terminal 104A is constructed with a wireless communication module 200, a control unit 202, a lamp unit 204, a receipt button 206, and an information display unit 208.

The wireless communication module 200 communicates with the management computer 100 through the wireless router 106A and the PAN coordinator 108. Specifically, the management computer 100 provides a part selection command and a command for terminating selection of parts to the display terminal 104A.

The control unit 202 turns on the lamp unit 204, in response to the part selection command transmitted from the management computer 100 and displays the part receipt guidance information on the information display unit 208, in response to the part selection command.

When receiving the receipt confirmation information, in response to a click of the receipt button 206 from a worker, the control unit 202 transmits the receipt confirmation information to the management computer 100.

In addition, the control unit 202 turns off the lamp unit 204 and deletes the part receipt guidance information displayed on the information display unit 208, in response to the command for terminating the selection of the parts transmitted from the management computer 100.

The lamp unit 204 is turned on or off under a control of the control unit 202.

The receipt button 206 is constructed with a predetermined button. The receipt button 206 provides the receipt confirmation information to the control unit 202, in response to a click of the button from outside.

The information display unit 208 displays information based on a control of the control unit 202.

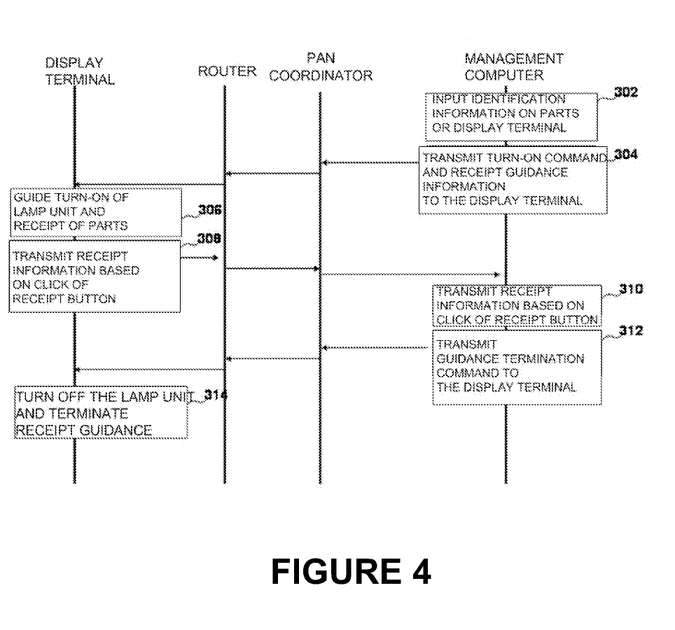

Now, the operation of the system for providing part selection information with the aforementioned structure will be described with reference to a functional block diagram illustrating a method of providing the part selection information according to an embodiment of the present invention shown in FIG. 4.

A manager or worker can input identification information on parts needed for a job or identification information on the display terminal adhered to the box including the parts (Step 302). Here, the manager or worker may input the identification information on the parts or identification information on the terminal through a network computer connected to the management computer 100 via a network.

When receiving the identification information on the parts, the management computer 100 reads identification information on the display terminal corresponding to the identification information on the parts from the management table.

When receiving the identification information on the display terminal from the manager or reading the identification information on the display terminal from the management table, the management computer 100 transmits the part selection command to the display terminal. The part selection command is wirelessly transmitted to the display terminal through the PAN coordinator 108 and the wireless routers 106A to 106H (Step 304).

The display terminal which receives the part selection command guides the worker so as to receive the parts included in the box by turning on the lamp unit in response to the part selection command and by displaying the part receipt guidance information on the information display unit (Step 306). Here, the worker presses the receipt button after receiving the parts included in the box to which the display terminal of which lamp unit is turned on is adhered.

When the worker clicks the receipt button, the display terminal transmits the receipt confirmation information to the management computer 100. The receipt confirmation information is wirelessly transmitted through the PAN coordinator 108 and the wireless routers 106A to 106H (Step 308).

The management computer 100 which receives the receipt confirmation information transmits the command for terminating the selection of the parts to the display terminal, after checking whether the parts are received based on the receipt confirmation information (Step 312).

The display terminal which receives the command for terminating the selection of the parts turns off the lamp unit therein and deletes the information displayed on the information display unit, in response to the command for terminating the selection of the parts (Step 314).

As described above, in the present invention, the worker can easily recognizes goods or parts to be obtained by adhering display terminals for displaying receipt guidance information to a worker to boxes which includes parts, so as to display the receipt guidance information on the display terminals, in response to the part selection command transmitted from the management computer.

Since the part selection information is provided to the worker through a wireless network which is constructed with the PAN coordinator and wireless routers, even when the structure of the system is changed based on a change of a working process, the system for providing the part selection information needs not to be modified, and accordingly, the maintenance and repair of the system are easy.

While the present invention has been particularly shown and described with reference to exemplary embodiments thereof, it will be understood by those skilled in the art that various changes in form and details may be made therein without departing from the spirit and scope of the invention as defined by the appended claims.

Therefore, the scope of the invention is defined not by the detailed description of the invention but by the appended claims, and all differences within the scope will be construed as being included in the present invention.

What is claimed is:

1. A system for providing part selection information, the system comprising:
a wireless network;
a plurality of display terminals adhered respectively to a plurality of boxes including predetermined parts, which displays receipt guidance information on corresponding parts, in response to a part selection command received through the wireless network; and
a management computer including a part management table to which identification information on the parts and identification information on the display terminals are mapped, which transmits the part selection command to a display terminal corresponding to identification information on parts or identification information on a display terminal through the wireless network when receiving the identification information on the parts or identification information on the display terminal,
wherein the display terminal displays receipt guidance information on the parts in response to the part selection command received from the management computer.

2. The system according to claim 1, wherein the identification information on the parts or identification information on the display terminal that is input into the management computer is input through the management computer or a network computer connected to the management computer.

3. The system according to claim 1,
wherein the display terminal transmits the receipt confirmation information to the management computer through the wireless network when externally receiving the receipt confirmation information and terminates an output of the receipt guidance information when receiving a command for terminating selection of a part from the management computer, and
wherein the management computer transmits the command for terminating the selection of the part to the display terminal based on the receipt confirmation information from the display terminal.

4. The system according to claim 1,
wherein the display terminal comprises:
a control unit which controls an operation of the display terminal;
a lamp unit constructed with a predetermined lamp, which operates under a control of the control unit; and
an information display unit which displays information provided from the control unit, and
wherein when receiving the part selection command from the management computer, the control unit turns on the lamp unit and displays receipt guidance information on the information display unit.

5. The system according to claim 4, wherein when receiving a command for terminating selection of parts from the management computer, the control unit of the display terminal turns off the lamp unit and deletes the receipt guidance information displayed on the information display unit.
